(19) United States
(12) Patent Application Publication
(10) Pub. No.: US 2004/0164843 A1
(43) Pub. Date: Aug. 26, 2004

(54) Door lock controller and the method thereof

(75) Inventors: Yoshinori Amagasa, Tokyo (JP); Tatsuya Michishige, Tokyo (JP)

Correspondence Address: MCGINN & GIBB, PLLC, 8321 OLD COURTHOUSE ROAD, SUITE 200, VIENNA, VA, 22182-3817, US

(73) Assignee: Fuji Jukogyo Kabushiki Kaisha, Tokyo (JP)

(21) Appl. No.: 10/780,879

(22) Filed: Feb. 19, 2004

(30) Foreign Application Priority Data
Feb. 20, 2003 (JP) P. 2003-042759

(51) Int. Cl. H04Q 1/00; B60R 25/00; H04B 1/00; G08B 29/00

(52) U.S. Cl. 340/5.2; 340/5.72

(57) ABSTRACT

When a request switch is actuated in a state where a signal outputted from a transmitter cannot be received, a cipher is inputted in accordance with the number of times the request switch is actuated. An answer back operation in response to the actuation of the request switch is performed by illuminating a lamp provided in a passenger compartment. An inputted cipher is checked by referring ciphers stored in a storage section in advance. When a coincidence exists, the control section outputs a control signal to a door lock motor drive section, thereby actuating a door lock motor to unlock a door lock.

### BACKGROUND OF THE INVENTION

1. Field of the Invention

The present invention relates to a door lock controller capable of locking and unlocking a door lock in accordance with a signal transmitted from a transmitter, and a method for controlling the door lock, particularly to a door lock mechanism for safely opening thereof without being thieved a cipher.

2. Description of the Related Art

There is a known unlocking method for unlocking a door lock by entering a cipher when a key is left in a passenger compartment. This method enables an operator to enter the cipher by combining to actuate an outer door handle with a beep. When an inputted cipher coincides with a predetermined cipher, the door lock is unlocked (see JP-A-61-5183).

The above described unlocking method actuates the outer door handle at the time of input of a cipher. Hence, an action required to operate the outer door handle becomes too large to be observed, and therefore there is much possibility to be thieved the cipher.

### SUMMARY OF THE INVENTION

An object of the present invention is to provide a door lock controller which enables safe unlocking while preventing a theft of a cipher, and a method for controlling the door lock.

In order to accomplish the object above, the following means are adopted. According to a first aspect of the present invention, there is provided a door lock controller comprising:

a transmitter for transmitting a signal including a specific identification code;

a receiver for receiving the signal transmitted;

a request switch for causing the receiver to start a receipt of the signal, wherein a door lock is locked or unlocked through an actuation of the request switch in accordance with the signal;

a determination section for determining that the receiver is incapable of receiving the signal;

a storage section for storing a cipher used for unlocking the door lock entered on the basis of an actuation of the request switch when the determination section has determined that the signal is incapable of receiving from the transmitter; and.

a door lock unlocking section for unlocking the door lock when a coincidence exists between the ciphers stored in advance and the cipher inputted through said actuation of the request switch and stored in the storage section.

According to a second aspect of the present invention, the door lock controller defined in the first aspect of the invention may further comprises:

an answer back (transponder) section for informing an operator of the actuation of the request switch,

wherein the storage section stores the cipher used for unlocking the door lock entered as a result of repeated actuations of the request switch.

According to a third aspect of the present invention, the door lock controller defined in the first aspect of the invention may further comprises:

an answer back (transponder) section for informing an operator that the actuation of the request switch is being continued,

wherein the storage section stores the cipher used for unlocking the door lock entered on the basis of the number of the answer back operations performed by the answer back section during the continuous actuation of the request switch.

According to the door lock controller defined in the first to third aspect of the present invention, the request switch is used for entering the cipher used for unlocking the door lock. Hence, an action required to enter the cipher can be made small and unobservable. Accordingly, there can be prevented a theft of the cipher, which would otherwise be possible at the time of the cipher entry, and hence the door lock can be unlocked safely.

According to a fourth aspect of the present invention, in the door lock controller defined in the second or third aspect of the invention, the answer back section may include an illumination section provided in a passenger compartment. According to the door lock controller defined in the fourth aspect of the present invention, the answer back section includes a light emitting section provided within the vehicle. Hence, a door lock controller having a high degree of safety can be provided at low cost.

According to a fifth aspect of the present invention, in the door lock controller defined in the second or third aspect of the invention, the answer back section may include an answer back indicator provided integrally with the request switch. According to the door lock controller defined in the fifth aspect of the present invention, the answer back section includes an answer back indicator provided integrally with the request switch. Hence, there can be provided answer back section having an excellent design.

According to a sixth aspect of the present invention, in the door lock controller defined in the fifth aspect of the invention, the answer back indicator may provide a different display depending on whether or not the transmitter is situated within a receivable range of the receiver. The door lock controller defined in the sixth aspect of the present invention enables an operator to readily ascertain whether or not the transmitter is situated within a receivable range of the receiver by an indication of the answer back indicator.

According to a seventh aspect of the present invention, in the door lock controller defined in the fifth aspect of the invention, the answer back indicator may provide a different display depending on the state of the door lock. The door lock controller defined in the seventh aspect of the present invention enables the operator to readily ascertain whether the door lock is locked or unlocked by the indication of the answer back indicator.

According to an eighth aspect of the present invention, in the door lock controller defined in one of the two to seventh aspects of the invention, the answer back section may include a sound (audio) section for informing the operator by means of a sound. The door lock controller defined in the eighth aspect of the present invention enables the operator to readily ascertain whether or not the request switch is actuated by means of a sound.

### BRIEF DESCRIPTION OF THE DRAWINGS

FIG. 1 is a view showing an outer door handle and a request switch provided on a door of a vehicle having a door lock controller according to a first embodiment of the invention;

FIG. 2 is a block diagram of the door lock controller according to the first embodiment;

FIG. 3 is a flowchart for describing an unlocking operation of the door lock controller of the first embodiment;

FIG. 4 is the flowchart for describing unlocking operation of the door lock controller according to a second embodiment of the invention;

FIG. 5 is the block diagram of the door lock controller according to a third embodiment of the invention;

FIG. 6 is the flowchart for describing the unlocking operation of a door lock controller according to the third embodiment of the invention;

FIG. 7 is the flowchart for describing the unlocking operation of the door lock controller according to a fourth embodiment of the invention; and

FIGS. 8A and 8B are views for showing an outer door handle and a request switch, which are provided on a door of a vehicle having the door lock controller according to-a fifth embodiment of the invention.

### DETAILED DESCRIPTION OF THE INVENTION

Door lock controllers and door lock controlling method according to embodiments of the invention will be described hereinbelow by reference to the drawings.

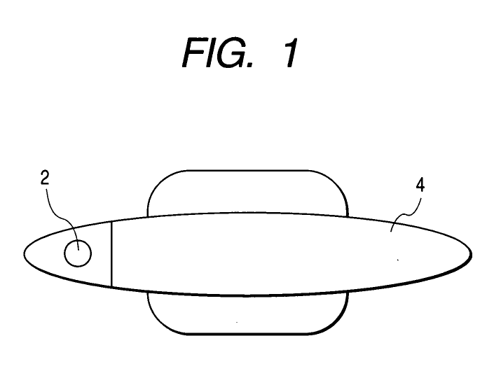

FIG. 1 is a view showing an outer door handle and a request switch, which are provided on a door of a vehicle having a door lock controller according to a first embodiment of the invention. As illustrated, a request switch 2 is provided in a vicinity of an outer door handle 4.

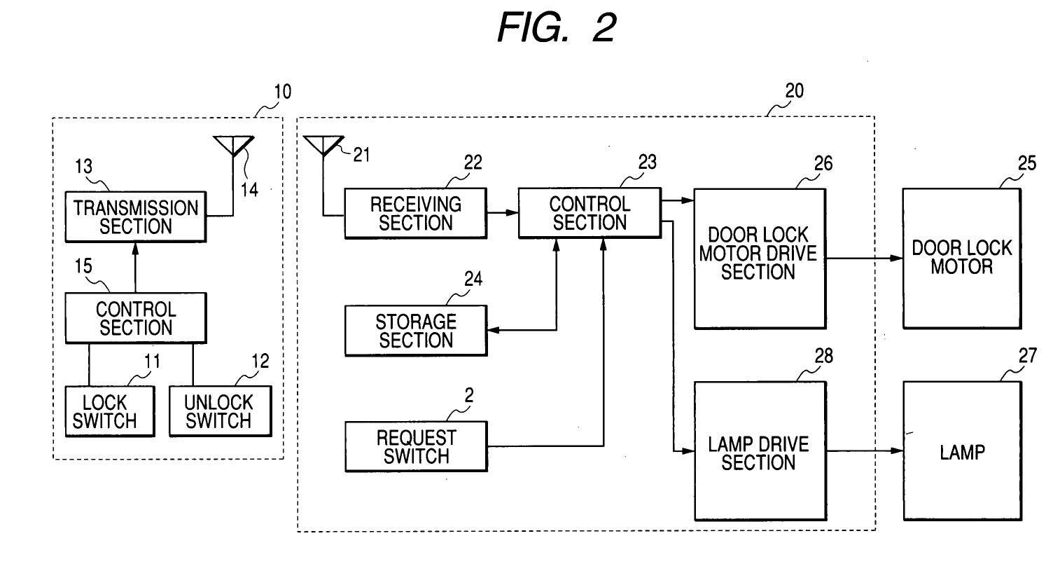

FIG. 2 is a block diagram showing the configuration of the door lock controller according to the first embodiment of the present invention. The door lock controller has a portable transmitter 10 and a receiver 20 mounted on the vehicle. In response to an operating action, the transmitter 10 performs an operation for locking and/or unlocking a door lock of the vehicle by communicating a signal including a specific identification code.

The transmitter 10 is equipped with a door lock switch 11 used for locking the door lock, a door unlock switch 12 used for unlocking the door lock, and a control section 15. The control section 15 detects an actuation of the switches and performs a control operation such that a transmission section 13 transmits a signal including a predetermined identification code by an antenna 14.

The receiver 20 is equipped with a receiving section 22 for receiving a signal outputted from the transmitter 10 by an antenna 21, and a control section 23 which performs a predetermined process described later in accordance with the signal received from the receiving section 22. The control section 23 is connected to the request switch 2 to be used for starting receipt of a signal by the receiver 20 and a storage section 24. The storage section 24 temporarily stores a cipher included in a received signal and preliminarily stores the cipher used for unlocking purpose. Further, a door lock motor 25 for locking and unlocking the door lock is connected to the control section 23 by a door lock motor drive section 26. Further, a lamp 27 used as answer back section and corresponds to a light emitting section provided in a passenger compartment; e.g., a key ring illumination lamp, a room lamp, a meter illumination lamp, or indicator lamps of switches, are connected to the control section 23 by a lamp drive section 28.

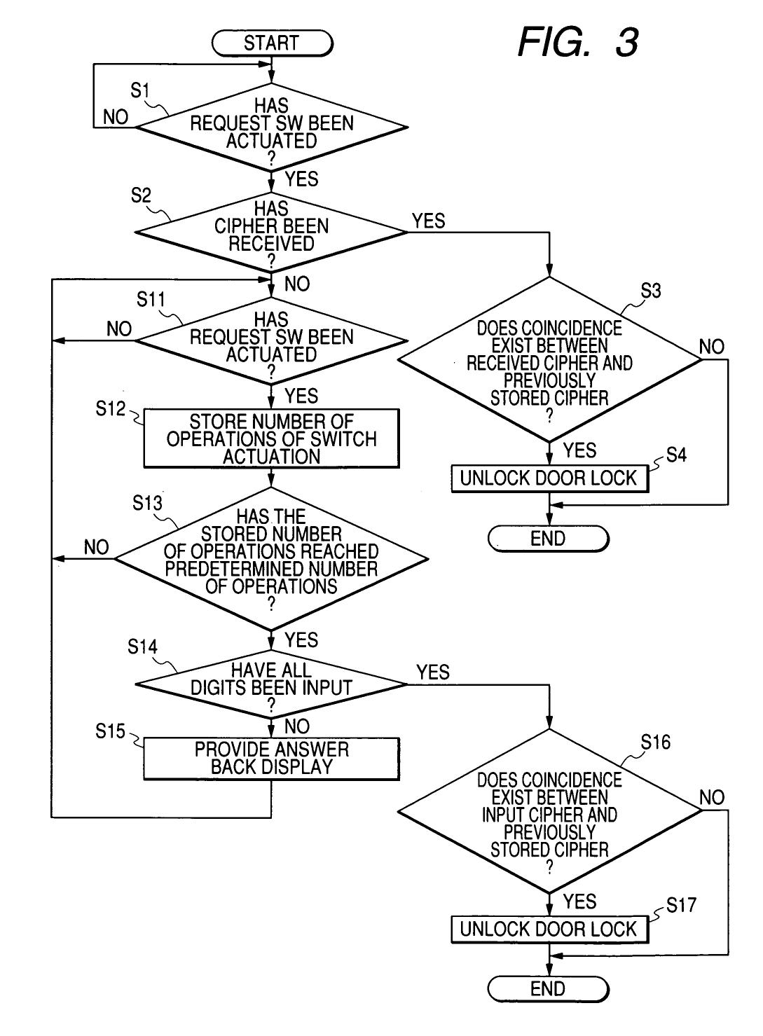

An unlocking operation of the door lock controller of the first embodiment will now be described by reference to a flowchart shown in FIG. 3.

A determination is made as to whether or not the request switch 2 is actuated (step S1). When the request switch 2 is actuated, the control section 23 of the receiver 20 determines whether or not a signal outputted from the transmitter. 10 can be received by the receiving section 22 (step S2).

When the receiving section 22 has properly received the signal from the transmitter 10, the received signal is checked against the cipher that has been stored in the storage section 24 in advance. When a coincidence exists between the inputted cipher and the previously stored cipher (step S3), the control section 23 outputs a control signal to the door lock motor drive section 26, whereby the door lock motor 25 is actuated to unlock the door lock (step S4).

When the receiving section 22 has failed to receive properly the signal from the transmitter 10; namely, when the operator has performed a locking operation while the transmitter 10 is left in a passenger compartment or when the operator has lost the transmitter, a receiving operation is determined to be inoperable, in view that the operator does not have any transmitter 10.

If the request switch 2 is actuated in a state in which the signal outputted from the transmitter 10 is not receivable (step S11), the number of actuating operations is stored in the storage section 24 every time the request switch 2 is actuated (step S12). A determination is made as to whether or not the number of operations of the request switch 2 has reached a predetermined number of times (step S13). When the cipher is “4213”, the request switch 2 is actuated four times for entering “4.”, When the number “4” has been inputted, the determination is made as to whether or not all digits of the cipher “4213” have been entered (step S14).

In this case, only an entry of the first digit has been performed thus far. Hence, an answer back display is provided (step S15), and a process returns to step S11. In relation to the answer back display, the control section 23 outputs a control signal to the lamp drive section 28, to thereby illuminate once any one of the lamps 27, e.g., the key ring illumination lamp, the room lamp, the meter illumination lamp, or the indicator lamps of the switches. The number of lamps to be illuminated is not limited to one. Two or more lamps may be illuminated simultaneously, and the number of illuminating operations is also not limited to one.

When all the digits of the cipher “4213” have been inputted through a repetition of processes from steps S11 to S15 (step S14), the thus inputted cipher is checked against the cipher stored in the storage section 24 beforehand (i.e., the cipher differing from the cipher to be checked against a signal outputted from the previously described transmitter 10). When the coincidence exists between the inputted cipher and the previously stored cipher (step S16), the control section 23 outputs a control signal to the door lock motor drive section 26, thereby actuating the door lock motor 25 to unlock the door lock (step S17).

The door lock controller of the first embodiment uses the request switch for entering the cipher in order to unlock the door lock. Hence, the action required to enter the cipher can be made small and unobservable. Therefore, there can be prevented the theft of the cipher, which would otherwise be possible at the time of input of the cipher, and the door lock can be unlocked safely. Further, the answer back is effected by illuminating the key ring illumination lamp, the room lamp, the meter illumination lamp, or the indicator lamps of the switches, which are provided in the passenger compartment. Hence, the door lock controller having a high level of the safety can be provided at a low cost.

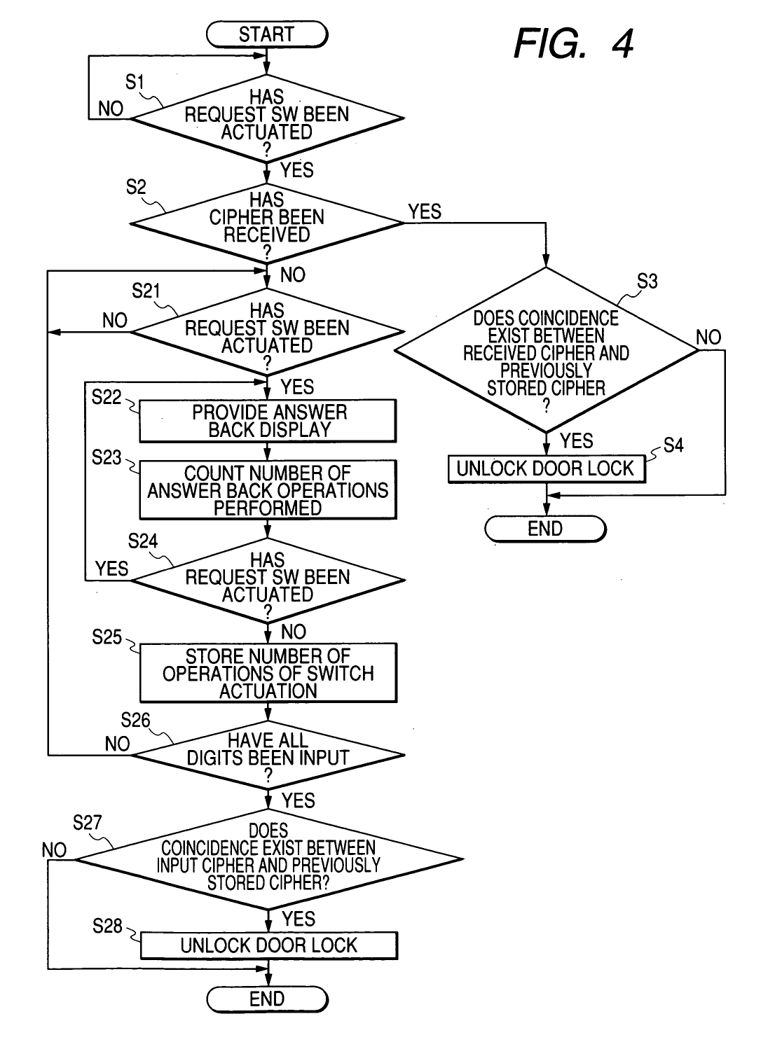

An unlocking operation of the door lock controller according to a second embodiment of the present invention will now be described by reference to a flowchart shown in FIG. 4. The configuration of the door lock controller of the second embodiment is identical with that of the door lock controller of the first embodiment shown in FIG. 2.

First, the determination is made as to whether or not the request switch 2 has been actuated (step S1). When the request switch 2 has been actuated, the control section 23 of the receiver 20 determines whether or not the receiving section 22 can receive the signal outputted from the transmitter 10 (step S2). When the control section 23 of the receiver 20 has determined that the receiving section 22 has received the signal outputted from the transmitter 10, performed is the process identical with: that pertaining to the flowchart of the first embodiment shown in FIG. 3.

When the receiving section 22 has failed to properly receive the signal from the transmitter 10; that is, when the operator has locked the door lock with the transmitter 10 being left in the passenger compartment or the operator has lost the transmitter 10, or when the operator does not have any transmitter 10, a receiving is determined to be impossible.

If the request switch 2 is actuated in a state in which the signal outputted from the transmitter 10 is not receivable (step S21), an answer back display is carried out (step S22). The answer back display is carried out at given intervals during a period of time in which an actuation of the request switch 2 is being carried out. Hence, the number of answer back display operations is counted every time the answer back display is carried out (step S23) In relation to the answer back display, the control section 23 outputs a control signal to the lamp drive section 28, to thereby illuminate once any one of the lamps 27; e.g., the key ring illumination lamp, the room lamp, the meter illumination lamp, or the indicator lamps of the switches.

The control section 23 makes a determination as to whether or not the request switch 2 is actuated (step S24). If the request switch 2 is not actuated, the number of times the answer back display is performed, which is counted in step S23, is stored in the storage section 24 as a cipher corresponding to one digit number (step S25). The answer back display is commenced as a result of the operator having actuated the request switch 2. During a period of time in which the actuation of the request switch 2 is being continued, the answer back display is carried out at given time intervals. Accordingly, in the case of a cipher of “4213”, when the number of times the answer back display is being performed has reached four with the view of entering “4”, the actuation of the request switch 2 is terminated, and-the digit “4” can be inputted.

The determination is made as to whether or not the entry of all the digits of the cipher “4213” has been performed (step S26). In this case, only the first digit has been entered, and hence the process returns to step S21. When the entry of all the digits “4213” has been performed through the repetition of the process from steps S21 to S26 (step S26), the thus inputted cipher is checked against the cipher that has been stored in the storage section 24 in advance. When a coincidence exists between the inputted cipher and the previously stored cipher (step S27), the control section 23 outputs a control signal to the door lock motor drive section 26, to thereby actuate the door lock motor 25 to unlock the door lock (step S28).

The door lock controller of the second embodiment uses the request switch for entering the cipher in order to unlock the door lock. Hence, the action required to enter the cipher can be made small and unobservable. Therefore, there can be prevented the theft of the cipher, which would otherwise be possible at the time of inputting the cipher, and the door lock can be unlocked safely. Further, the answer back is effected by illuminating the key ring illumination lamp, the room lamp, the meter illumination lamp, or the indicator lamps of the switches, which are provided in the passenger compartment. Hence, the door lock controller having a high level of the safety can be provided at the low cost.

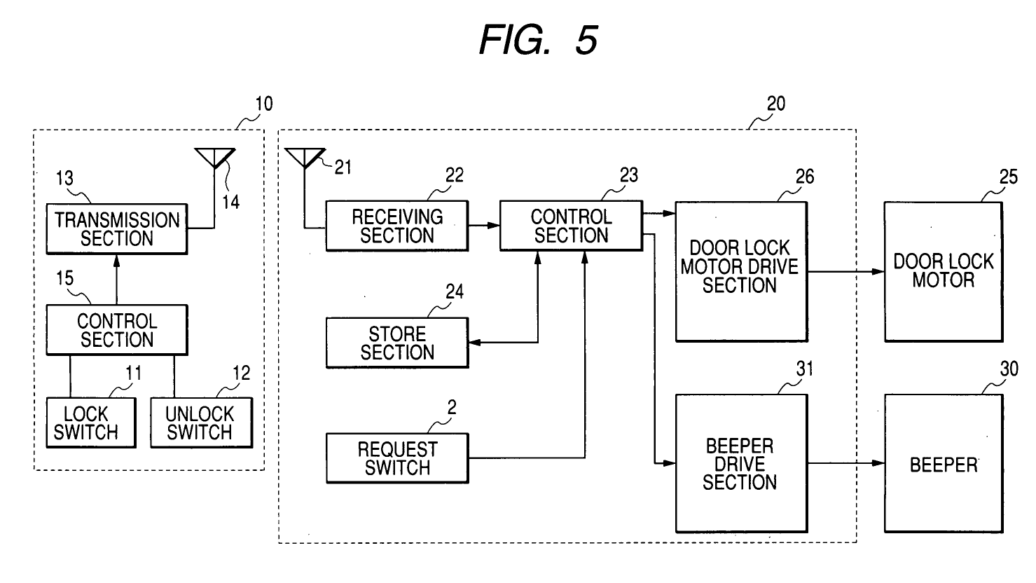

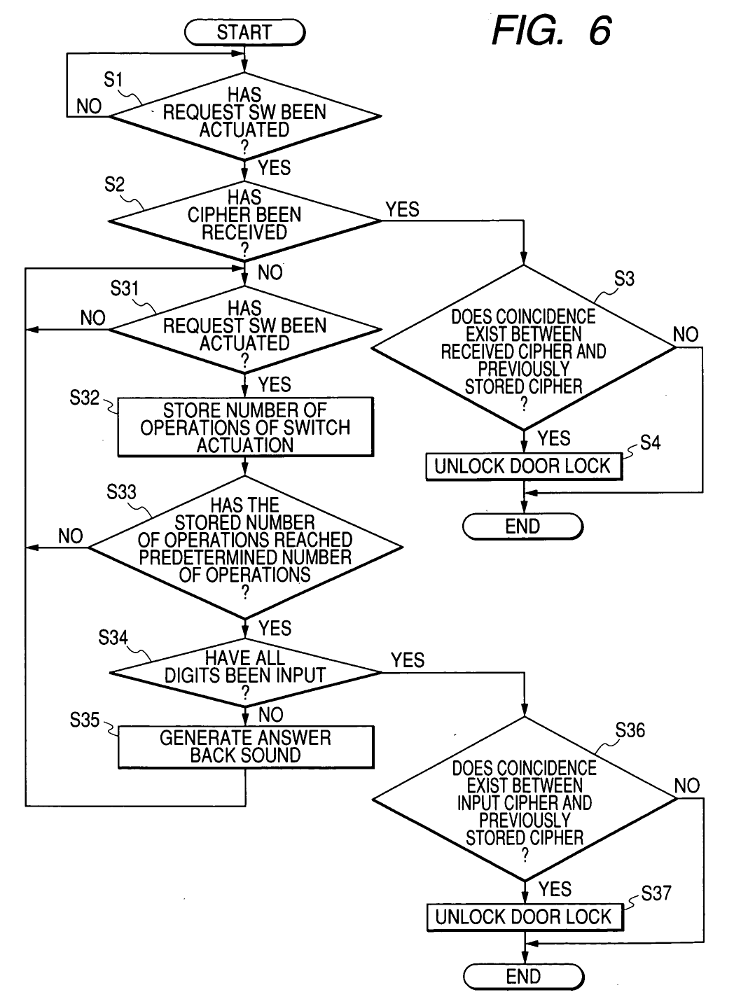

An unlocking operation of the door lock controller according to a third embodiment will now be described by reference to the block diagram shown in FIG. 5 and the flowchart shown in FIG. 6. The door lock controller of the third embodiment has a beeper 30 and a beeper drive section 31 instead of the lamps 27 and the lamp drive section 28 of the door lock controller of the first embodiment shown in FIG. 2.

First, the determination is made as to whether or not the request switch 2 is actuated (step S1). When the request switch 2 has been actuated, the control section 23 of the receiver 20 determines whether or not the receiving section 22 can receive the signal from the transmitter 10 (step S2) When the control section.23 of the receiver 20 determines that the receiving section 22 has received the signal from the transmitter 10, there is performed the process identical with that pertaining to the flowchart that relates to the first embodiment and is shown in FIG. 3.

When the request switch 2 has been actuated while the receiving section 22 cannot receive any signal from the transmitter 10 (step S31), the number of actuating operations is stored in the storage section 24 every time the request switch 2is actuated (step S32). The determination is made as to whether or not the number of times the request switch 2 is actuated has reached a predetermined number of times (step S33). When the cipher is “4213,” the request switch 2 is actuated four times with the view of entering “4.” When the number “4” has been inputted, the determination is made as to whether or not all the digits of the cipher “4213” have been inputted (step S34).

At this time, only the first digit has been entered. Hence, an answer back sound is inputted (step S35), and process returns to step S31. The answer back sound is produced by the control section 23 outputting the control signal to the beeper drive section 31 and the beeper 30 producing a beep once.

When all the digits of the cipher “4213” have been inputted through the repetition of the processes pertaining to steps S31 to S35 (step S34), the cipher is checked against the cipher stored in the storage section 24 beforehand. When a coincidence exists between the inputted cipher and the previously stored cipher (step S36), the control section 23 outputs the control signal to the door lock motor drive section 26, thereby driving the door lock motor 25 so as to unlock the door lock (step S37).

The door lock controller of the third embodiment uses the request switch for entering the cipher in order to unlock the door lock. Hence, the action required to enter the cipher can be made small and unobservable. Therefore, there can be prevented the theft of the cipher, which would otherwise be possible at the time of inputting the cipher, and the door lock can be unlocked safely.

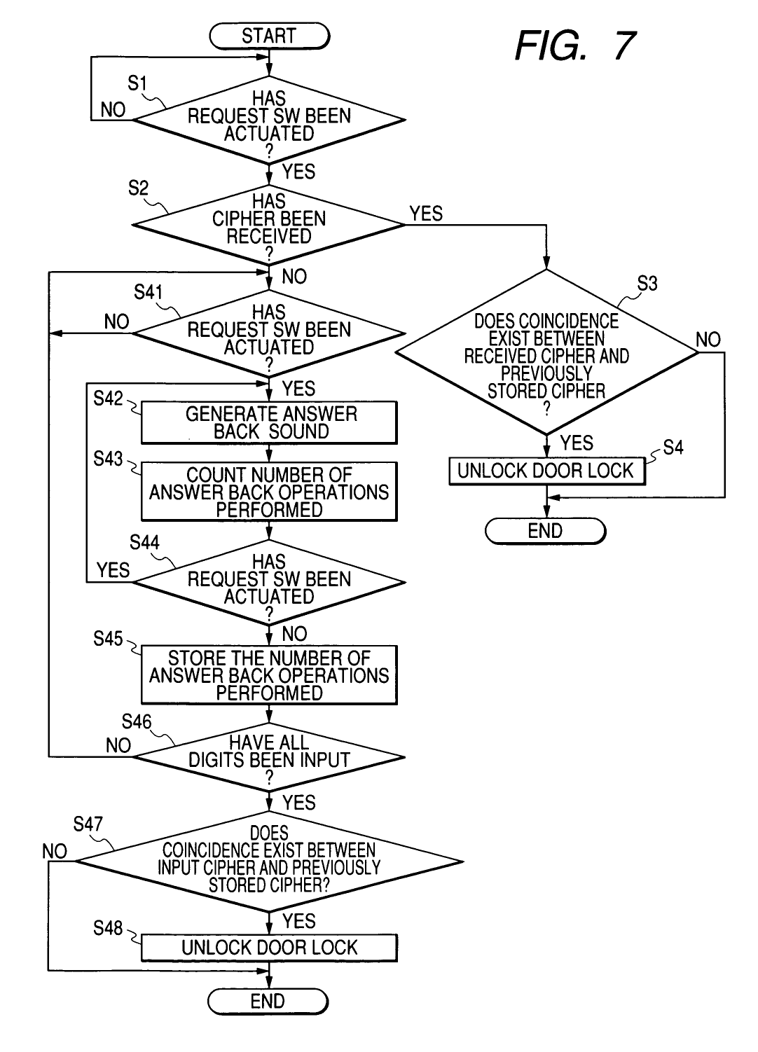

An unlocking operation of the door lock controller according to a fourth embodiment will now be described by reference to a flowchart shown in FIG. 7. The configuration of the door lock controller of the fourth embodiment is identical with that of the door lock controller of the third embodiment shown in FIG. 5.

First, the determination is made as to whether or not the request switch 2 has been actuated (step S1). When the request switch 2 has been actuated, the control section 23 of the receiver 20 determines whether or not the receiving section 22 can receive a signal from the transmitter 10 (step S2). When the control section 23 of the receiver 20 determines that the receiving section 22 has received the signal from the transmitter 10, there is performed the process identical with the flowchart that relates to the first embodiment and is shown in FIG. 3.

If the request switch 2 is actuated in the state in which the receiving section 22 cannot receive the signal from the transmitter 10 (step S41), the answer back sound is generated (step S42). The answer back sound is generated at the given time intervals during the period of time in which the request switch 2 is being actuated continuously. Hence, the number of the answer back sounds is counted every time the answer back sound is generated (step S43). In relation to the answer back sound, the control section 23 outputs the control signal to a beep drive section 31, to thereby cause the beeper 30 to produce a beep.

The control section 23 makes the determination as to whether or not the request switch 2 is being actuated continuously (step S44). If the request switch 2 is not being actuated continuously, the number of the answer back sounds counted in step S43 is stored in the storage section 24 as the cipher corresponding to one digit (step S45). Specifically, when the operator actuates the request switch 2, the answer back sound is commenced (or started). During the period of time in which the request switch 2 is being actuated continuously, the answer back sound is produced at the given time intervals. Accordingly, in the case of the cipher of “4213, ” when the number of the answer back sounds has reached four in order to enter “4”, the actuation of the request switch 2 is terminated, and “4” can be inputted.

The determination is made as to whether or not the entry of all the digit numbers of the cipher “4213” has been performed (step S46). In this case, only the first digit number has been entered, and hence the process returns to step S41. When the entry of all the digit numbers “4213” has been performed through the repetition of the process from steps S41 to S46 (step S46), the thus inputted cipher is checked against the cipher stored in the storage section 24 in advance. When the coincidence exists between the inputted cipher and the previously stored cipher (step S47), the control section 23 outputs the control signal to the door lock motor drive section 26, to thereby actuate the door lock motor 25 to unlock the door lock (step S48).

The door lock controller of the fourth embodiment uses the request switch for entering the cipher in order to unlock the door lock. Hence, the action required to enter the cipher can be made small and unobservable. Therefore, there can be prevented the theft of the cipher, which would otherwise be possible at the time of inputting the cipher, and the door lock can be unlocked safely.

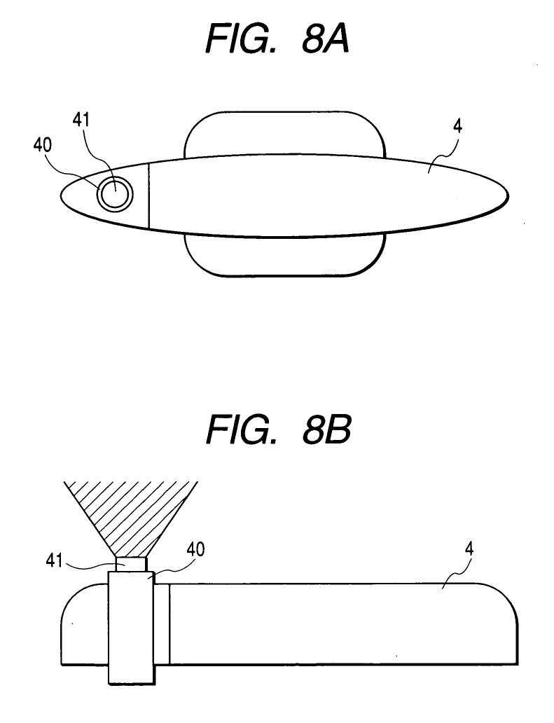

By reference to FIGS. 8A and 8B, the door lock controller according to a fifth embodiment of the present invention will now be described. Here, FIG. 8A is a plan view showing an outer door handle and-the request switch, which are provided on a door of a vehicle having the door lock controller of the fifth embodiment, and FIG. 8B is a side view. As illustrated, a request switch 40 is provided in the vicinity of the outer door handle 4. An answer back indicator lamp 41 constituted integrally with the request switch 40 is provided at the center of the request switch 40. The answer back indicator lamp 41 has an LCF or the like. The directivity of a light is limited so that only the operator can view the indicator lamp 41. The configuration of the door lock controller of the fifth embodiment is identical with that of the door lock controller according to the first embodiment shown in FIG. 2. An unlocking operation is identical with that provided in the flowchart shown in FIG. 3 or 4.

In the door lock controller of the fifth embodiment, the answer back indicator lamp is provided integrally with the request switch 40. Hence, the answer back section with an excellent design can be provided.

The door lock controller of the fifth embodiment may be structured in such a way that the answer back indicator lamp can provide a different display on the basis of whether or not the transmitter is situated within a receivable range of the receiver. For instance, when the transmitter is situated within the receivable range, the answer back indicator lamp is caused to blink. In contrast, when the transmitter is not situated within the receivable range, the answer back indicator lamp is illuminated. Alternatively, when the transmitter is situated within the receivable range, a red answer back indicator lamp is illuminated. In contrast, when the transmitter is not situated within the receivable range, a blue answer back indicator lamp is illuminated. By illuminating the answer back indicator lamp, the door lock controller enables the operator to readily ascertain whether or not the transmitter is situated within the receivable range.

In the door lock controller of the fifth embodiment, the answer back indicator lamp may provide a different display depending on the state of the door lock. For instance, when the door lock remains locked, the answer back indicator lamp is caused to blink. When the door lock remains unlocked, the answer back indicator lamp is illuminated. Alternatively, when the door lock remains locked, a red answer back indicator lamp is illuminated, and when the door lock remains unlocked, a blue answer back indicator lamp is illuminated. By the indication of the answer back indicator lamp, the door lock controller enables the operator to readily ascertain whether the door lock is locked or unlocked.

In the first, second, and fifth embodiments, the answer back operations are performed through the illuminations of the lamp. In the third and fourth embodiments, the answer back operation is performed through generation of a beep. However, the answer back operation may be effected by, for example, extending and retracting an audio antenna.

The door lock controller of the present invention employs the request switch for the cipher entry to be used for unlocking the door lock. Hence, the action required to input the cipher can be made small and unobservable. Accordingly, there can be prevented theft of the cipher, which would otherwise be possible at the time of the cipher entry, and the door lock can be unlocked safely. Further, when the illumination section provided in the passenger compartment is used as the answer back section, the door lock controller having a high degree of the safety can be provided at the low cost.

The disclosure of Japanese Patent Application No. 2003-042759 filed on Feb. 20, 2003 including the specification, the drawings and abstract is incorporated herein by reference in its entirety. While the presently preferred embodiments of the present invention have been shown and described, it is to be understood that these disclosures are for the purpose of illustration and that various changes and modifications may be made without departing from the scope of the present invention as set forth in the appended claims.

What is claimed is:

1. A door lock controller comprising:
a transmitter for transmitting a signal including a specific identification code;
a receiver for receiving the signal transmitted;
a request switch for causing the receiver to start a receipt of the signal, wherein a door lock is locked or unlocked through an actuation of the request switch in accordance with the signal;
a determination section for determining that the receiver is incapable of receiving the signal;
a storage section for storing a cipher used for unlocking the door lock entered on the basis of an actuation of the request switch when said determination section has determined that the signal is incapable of receiving from the transmitter; and
a door lock unlocking section for unlocking the door lock when a coincidence exists between a cipher stored in advance and the cipher inputted through said actuation of the request switch and stored in said storage section.

2. The door lock controller according to claim 1, further comprising:
an answer back section for informing an operator of the actuation of the request switch,
wherein said storage section stores the cipher used for unlocking the door lock entered as a result of repeated actuations of the request switch.

3. The door lock controller according to claim 1, further comprising:
an answer back section for informing an operator that the actuation of the request switch is being continued, wherein said storage section stores the cipher used for unlocking the door lock entered on the basis of the number of the answer back operations performed by said answer back section during the continuous actuation of the request switch.

4. The door lock controller according to claim 2, wherein:
said answer back section includes an illumination section provided in a passenger compartment.

5. The door lock controller according to claim 3, wherein:
said answer back section includes an illumination section provided in a passenger compartment.

6. The door lock controller according to claim 2, wherein:
said answer back section includes an answer back indicator provided integrally with the request switch.

7. The door lock controller according to claim 3, wherein:
said answer back section includes an answer back indicator provided integrally with the request switch.

8. The door lock controller according to claim 6, wherein:
said answer back indicator provides a different display depending on whether or not the transmitter is situated within a receivable range of the receiver.

9. The door lock controller according to claim 7, wherein:
said answer back indicator provides a different display depending on whether or not the transmitter is situated within a receivable range of the receiver.

10. The door lock controller according to claim 6, wherein:
said answer back indicator provides a different display depending on states of the door lock.

11. The door lock controller according to claim 7, wherein:
said answer back indicator provides a different display depending on states of the door lock.

12. The door lock controller according to claim 2, wherein:
said answer back section includes a sound section for informing the operator by means of a sound.

13. The door lock controller according to claim 3, wherein:
said answer back section includes a sound section for informing the operator by means of a sound.

14. A method for controlling a door lock with a door lock controller having a transmitter for transmitting a signal including a specific identification code, a receiver for receiving the signal transmitted from the transmitter, and a request switch for causing the receiver to start a receipt of the signal, wherein a door lock is locked or unlocked through an actuation of the request switch in accordance with the signal received by the receiver, said controlling method comprising the steps of:
determining that the receiver is incapable of receiving the signal from the transmitter;
storing a cipher used for unlocking the door lock entered on the basis of an actuation of the request switch when it is determined that the signal is incapable of receiving from the transmitter; and
unlocking the door lock when a coincidence exists between a cipher stored in advance and the cipher inputted through said actuation of the request switch and stored.

15. The door lock controlling method according to claim 14, further comprising:
informing an operator of the actuation of the request switch as an answer back operation,
wherein said storing step stores the cipher used for unlocking the door lock entered as a result of repeated actuations of the request switch.

16. The door lock controlling method according to claim 14, further comprising:
informing an operator that the actuation of the request switch is, continued as an answer back operation,
wherein said storing step stores the cipher used for unlocking the door lock entered on the basis of the number of the answer back operations performed during the continuous actuation of the request switch.
